(19) United States
(12) Patent Application Publication
(10) Pub. No.: US 2018/0027750 A1
(43) Pub. Date: Feb. 1, 2018

(54) INNER RECEPTACLE APPARATUS FOR CUT FLOWERS

(71) Applicant: Karen English, Naas (IE)

(72) Inventor: Karen English, Naas (IE)

(21) Appl. No.: 15/659,252

(22) Filed: Jul. 25, 2017

(30) Foreign Application Priority Data
Jul. 26, 2016 (IE) S2016/0187

(51) Int. Cl. A01G 9/02; A47G 7/06

(52) U.S. Cl. CPC A01G 9/02; A47G 7/06; A47G 2007/066

(57) ABSTRACT

Provided is an inner receptacle apparatus for locating within a larger open-ended outer container, the inner receptacle apparatus comprising: a receptacle body for receiving cut flowers; and one or more adjustable attachment members for locating the receptacle body within the outer container.

### CROSS-REFERENCE TO RELATED APPLICATION

The present application relates and claims priority to Application No.: S2016/0187, filed on 26 Jul. 2016 in Ireland, the entirety of which is hereby incorporated by reference.

### FIELD

The invention relates to an inner receptacle apparatus for cut flowers, and more particularly, a receptacle apparatus configured to be positioned in a larger outer container such as a vase or flower pot.

### BACKGROUND OF THE INVENTION

A vase is an open container, often used to hold flowers or for decoration. Vases may be manufactured from a number of materials, such as ceramics, glass, non-rusting metals, such as aluminum, brass, bronze or stainless steel. Vases are often decorated.

Vases generally have a similar shape. In this regard, a vase includes an open upper end defining a rim, sidewalls and a vase bottom defining a receptacle for receiving flowers, flower stems or other similarly shaped items. The receptacle can also hold water for keeping fresh flowers accommodated in the vase. Some vases may have a conical or frustoconical shape thereby allowing the flowers stems to reach the bottom of the vase. FIG. 1 is a perspective view of a conventional vase 10 having the above-described shape.

Some vases may also define a neck, where the vase is given more height. Also, a lip may be defined on the rim, that is, on the top of the sidewalls where the vase flares back out at the top. Some vases also have handles.

Flower pots are other containers for cultivating and displaying flowers and other plants. Flower pots may be made from terracotta, plastic, wood, stone, or sometimes biodegradable material. There are often holes in the bottoms of flower pots, to allow excess water to flow out, sometimes to a saucer that is placed under the flower pot.

Cut flowers are commonly displayed in vases. Cut flowers are flowers or flower buds that have been cut from the plant bearing them. Such flowers are usually removed from the plant for indoor decorative use. Typical uses are in vase displays, wreaths and garlands. Cut flowers can also be harvested from the wild. As such, the cut flowers may have stems of different thicknesses and length.

Flowers of different heights may not look right in certain vases, or it may be difficult to arrange a variety of flowers of different sizes in the same vase. Some flowers may not be suitable for vases of certain heights or the size of the open upper end.

Therefore there is a need to provide a solution to overcome the above drawbacks.

### SUMMARY

According to the present disclosure there is provided an inner receptacle apparatus as detailed in claim 1. Advantageous features are provided in the dependent claims.

### BRIEF DESCRIPTION OF THE DRAWINGS

The present application will now be described with reference to the accompanying drawings in which:

FIG. 1 is a perspective view of a conventional vase;

FIG. 2 is a perspective view of an inner receptacle apparatus according to an embodiment of the present disclosure;

FIG. 3 is a top plan view of the inner receptacle apparatus of FIG. 2, according to an embodiment of the present disclosure;

FIG. 4 is a top plan view of an inner receptacle apparatus having three adjustable attachment members, according to another embodiment of the present disclosure;

FIG. 5 is a detailed side view of an adjustable attachment member of the inner receptacle apparatus, according to an embodiment of the present disclosure;

FIG. 6 is a top plan view of an apertured lid for the inner receptacle apparatus, according to an embodiment of the present disclosure; and

FIG. 7 is a side view of an inner receptacle apparatus for receiving the apertured lid of FIG. 6, according to an embodiment of the present disclosure.

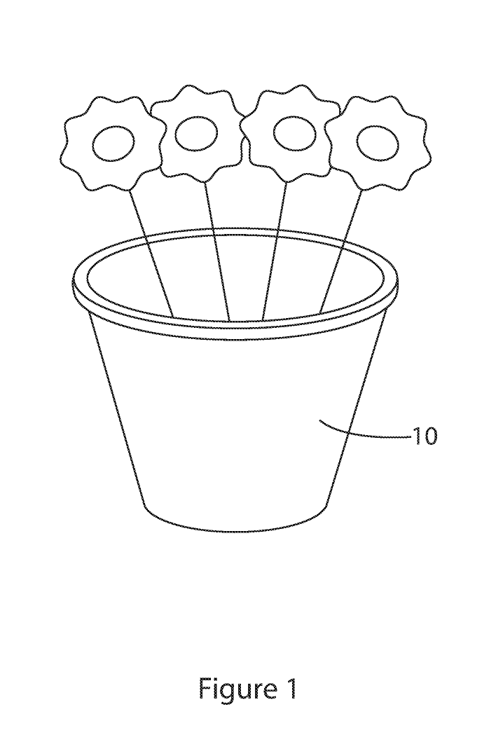

### DETAILED DESCRIPTION OF THE DRAWINGS

The present disclosure provides an inner receptacle apparatus for locating within a larger open-ended outer container. The inner receptacle apparatus comprises a receptacle body for receiving cut flowers, and one or more adjustable attachment members for locating the receptacle body within the outer container. In the context of the present disclosure, the outer container may be any suitable receptacle such as a conventional vase or flower pot. By locating the receptacle body of the inner receptacle apparatus within an outer container, flowers with shorter stems can be accommodated in the inner receptacle apparatus alongside flowers with longer stems in the outer container. In this manner, an arrangement of cut flowers including a variety of flowers with different stem lengths can be facilitated. The inner receptacle apparatus may have a variety of sizes to cater for larger outer containers such as commercial florist cases.

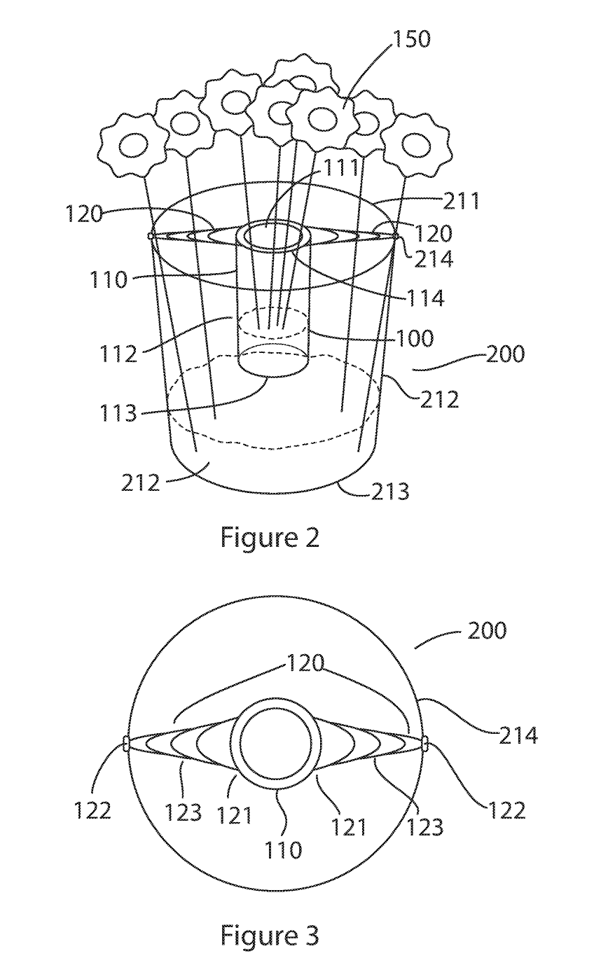

FIG. 2 is a perspective view of an inner receptacle apparatus 100 according to an embodiment of the present disclosure. Referring to FIG. 2, the inner receptacle apparatus 100 is configured to be positioned within a larger outer container 200 such as a conventional vase or flower pot. The inner receptacle apparatus 100 comprises a receptacle body 110 for receiving cut flowers 150; and one or more adjustable attachment members 120 for locating the receptacle body 110 within the outer container 200. The one or more adjustable attachment members 120 are configured to attach the receptacle body 110 to the outer container 200. The receptacle body 110 may have the same structure as that of a conventional vase, that is, an open upper end 111, sidewalls 112 and a base 113. An upper rim 114 is defined at the open upper end 111 of the receptacle body 110. Each of the upper rim 114 and the base 113 may define a circular shape. However, the present disclosure is not limited thereto, and the open upper end 111 and base 113 may define different shapes such as square, rectangular and other polygonal shapes. The receptacle body 110 is illustrated in FIG. 2 as having a cylindrical shape, but the present disclosure is not limited thereto, and the receptacle body 110 may have other shapes such as a conical or frustoconical shape. The receptacle body 110 may be formed from or more materials, such as ceramics, glass, acrylic, or a metal such as aluminum, brass, bronze or stainless steel. An apertured lid (not shown in FIG. 2) may be provided at the open upper end 111 of the receptacle body 110 for placing and keeping flowers in an arrangement.

When positioned in an outer container such as a vase or flower pot, the inner receptacle apparatus 100 may be configured such that the receptacle body 110 can be suspended within the outer container. That is, referring to FIG. 2, the inner receptacle apparatus 100 may be configured such that a space is provided between the base 113 of the receptacle body and a base 213 of the outer container 200. In this manner, cut flowers of relatively short stem lengths can be received in the inner receptacle apparatus 100, and cut flowers of relatively long stem lengths can be received in the area of the outer container 200 on the outer periphery of the inner receptacle apparatus 100. Accordingly, an arrangement of cut flowers including a variety of flowers with different stem lengths can be accommodated alongside each other.

Further, the one or more adjustable attachment members 120 may function to separate the sidewalls 112 of the receptacle body 110 from sidewalls 212 of the outer container 200, thus defining a space for cut flowers to be received in the outer container 200. The open upper end 111 of the receptacle body 110 may be positioned at substantially the same height as an open upper end 211 of the outer container 200. In this regard, the inner receptacle apparatus 100 may be configured to be located in a central upper portion of the space defined within the outer container 200. As mentioned above, this configuration enables cut flowers to be positioned in the area of the outer container 200 on an outer periphery of the inner receptacle apparatus 100.

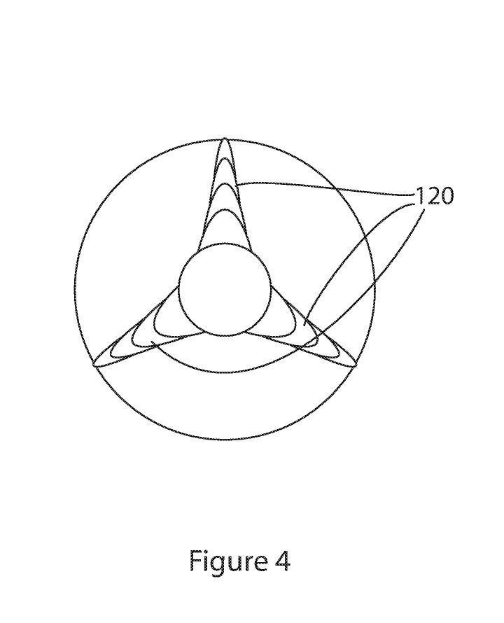

The one or more adjustable attachment members 120 may have a linear elongatable structure. It will thus be understood that the length of the one or more adjustable attachment members 120 may be adjustable. That it, by adjusting the length of the one or more adjustable attachment members 120, the inner receptacle apparatus 100 of the present disclosure may be configured to be located within outer containers of various sizes and diameters. FIG. 3 is a top plan view of the inner receptacle apparatus of FIG. 2, according to an embodiment of the present disclosure. Referring to FIG. 3, the one or more adjustable attachment members 120 comprises two adjustable attachment members 120. However, the present disclosure is not limited thereto, and there may be any number of adjustable attachment members 120 provided to support the receptacle body 110. For example, the one or more adjustable attachment members 120 may comprise three adjustable attachment members 120 as illustrated in FIG. 4.

Referring again to FIG. 3, each of the one or more adjustable attachment members 120 may comprise a first end 121 for attachment to the receptacle body 110, a linear elongatable body 123, and a second end 122 for releasable attachment to the outer container 200. It will be understood that first and second ends 121 and 22 are provided at either end of the linear elongatable body 123. The first end 121 may be integrally formed with the linear elongatable body 123. Also, the linear elongatable body 123 may be integrally formed with the second end 122. A description of the linear elongatable body 123 is provided below.

The first end 121 may be fixedly or releasably attached to the receptacle body 110. In this regard, the first end 121 may be attached to the receptacle body 110 using any suitable fastener. In one embodiment, the first end 121 may be attached to the upper rim 114 of the receptacle body 110. However, in other embodiments, the first end 121 may be attached to other portions of the receptacle body 110, such as for example the sidewalls 112 or base 113 of the receptacle body 110. In another embodiment, the first end 121 may be configured to be attached to the receptacle body 110 while being moveable about the receptacle body 110. For example, the one or more adjustable attachment members 120 may be configured to be moved around the upper rim 114 of the receptacle body 110. The one or more adjustable attachment members 120 may be configured to be hinged about the receptacle body 110. Each of the one or more adjustable attachment members 120 may be hingeablely coupled to the receptacle body 110. The hinging mechanism may be configured to restrict the rotation of the adjustable attachment member in the vertical plane.

It will be understood that the second end 122 may be configured to be releasably attached to the outer container 200. In this manner, the inner receptacle apparatus 100 is configured to be a self-contained apparatus which may be installed in and removed from outer containers of different sizes and shapes. In this regard, the second end 122 may comprise a fastener for releasable attachment to the outer container 200. More particularly, the fastener may be configured for releasable attachment to an upper rim 214 of the outer container 200. In this regard, the fastener may comprise a hook, claw, clip, or any other suitable device for releasably attaching the one or more adjustable attachment members 120 to the outer container 200. It will be understood that the upper rim 214 of the outer container 200 may define a lip protruding outwards. In an embodiment of the present disclosure, the second end 122 of the one or more adjustable attachment members 120 may be releasably attachable to the linear elongatable body 123. This enables fasteners of different structures to be used to attach the inner receptacle apparatus 100 to the outer container 200 depending on the structure of the outer container 200. For example, where the outer container 200 includes a lip on the upper rim 214, a hook may be a suitable fastening device for the second end 122 of the one or more adjustable attachment members 120.

Each of the one or more adjustable attachment members 120 may be configured to be adjusted in length along their longitudinal axis. The one or more adjustable attachment members 120 may be constrained to be adjusted in their longitudinal axis only and thus configured not to be adjusted in any other axis. That is, the one or more adjustable attachment members 120 are configured to be prevented from bending or flexing. Due to this property, the one or more adjustable attachment members 120 may be configured to connect the upper rim 114 of the receptacle body 110 with the upper rim 214 of the outer container 200. In use, the one or more adjustable attachment members 120 may extend in a substantially horizontal plane from the upper rim 114 of the receptacle body 110 to the upper rim 214 of the outer container 200.

The one or more adjustable attachment members 120 may have various structures in order to be adjustable. More particularly, the linear elongatable body 123 may have various structures to enable the adjustable attachment member 120 to be adjusted in length. In one embodiment, the linear elongatable body 123 may comprise a retractable spring such as a helical or coil spring. In another embodiment, the linear elongatable body 123 may comprise a telescopic arrangement. In another embodiment, the linear elongatable body 123 may comprise a retractable chain arrangement. The one or more adjustable attachment members 120 may be each configured to be adjustable in their longitudinal axis independent of each other. As mentioned above, the inner receptacle apparatus 100 may be configured to be located in a central upper portion of the space defined within the outer container 200. However, the present disclosure is not limited thereto, and the inner receptacle apparatus 100 may be configured to be located in other areas within the outer container 200. Having a plurality of adjustable attachment members 120 provides increased supporting strength. By variously adjusting the length of the one or more individual adjustable attachment members 120, the receptacle body 110 can be located at various positions within the outer container 200. For example, the inner receptacle apparatus 100 may be configured so that the receptacle body 110 can be positioned adjacent to or contacting inner sidewalls of the outer container 200.

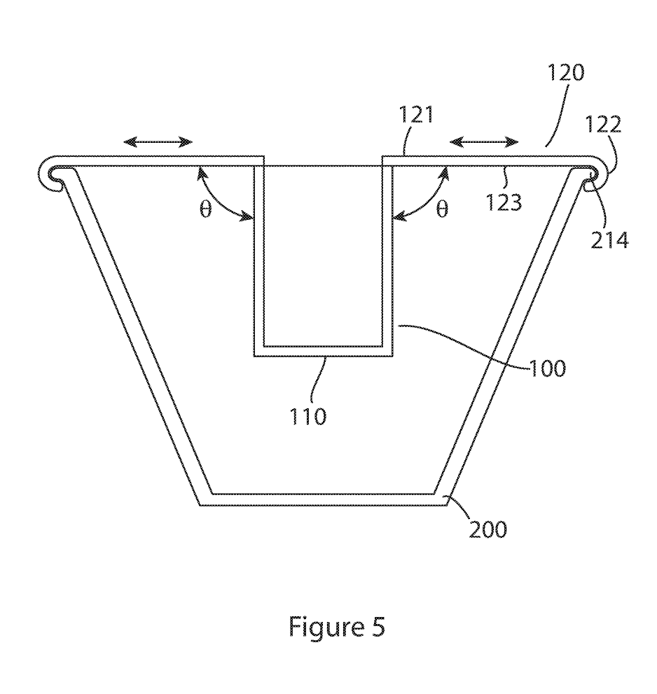

FIG. 5 is a detailed side view of an adjustable attachment member 120 of the inner receptacle apparatus 100, according to an embodiment of the present disclosure. Referring to FIG. 5, the one or more adjustable attachment members 120 may be configured to be hinged about the receptacle body 110. Each of the one or more adjustable attachment members 120 may be hingeablely coupled to the receptacle body 110. More particularly, the one or more adjustable attachment members 120 may be configured to be hinged about the first end 121 thereof. The one or more adjustable attachment members 120 may be configured to be hinged through an angle θ as shown in FIG. 5. The angle θ may be approximately 90 degrees. The one or more adjustable attachment members 120 may be configured to be hinged parallel to the sidewalls 112 of the receptacle body when not in use, such as for example when the inner receptacle apparatus 100 is being stored, in order to reduce its footprint. The one or more adjustable attachment members 120 may be configured to be hinged only to a substantially horizontal plane when in use. The hinging mechanism may be configured to restrict the rotation of the adjustable attachment member 120 in the vertical plane. More particularly, the hinging mechanism may be configured to limit the rotation of the adjustable attachment member 120 beyond a substantially horizontal alignment. Along with the second end 122 being attached to the outer container 200, such a hinge constraint mechanism prevents the receptacle body 110 from sagging within the outer container 200. Accordingly, the inner receptacle apparatus 100 may be configured so that the open upper end 111 of the receptacle body 110 is positioned at substantially the same height as the open upper end 211 of the outer container 200.

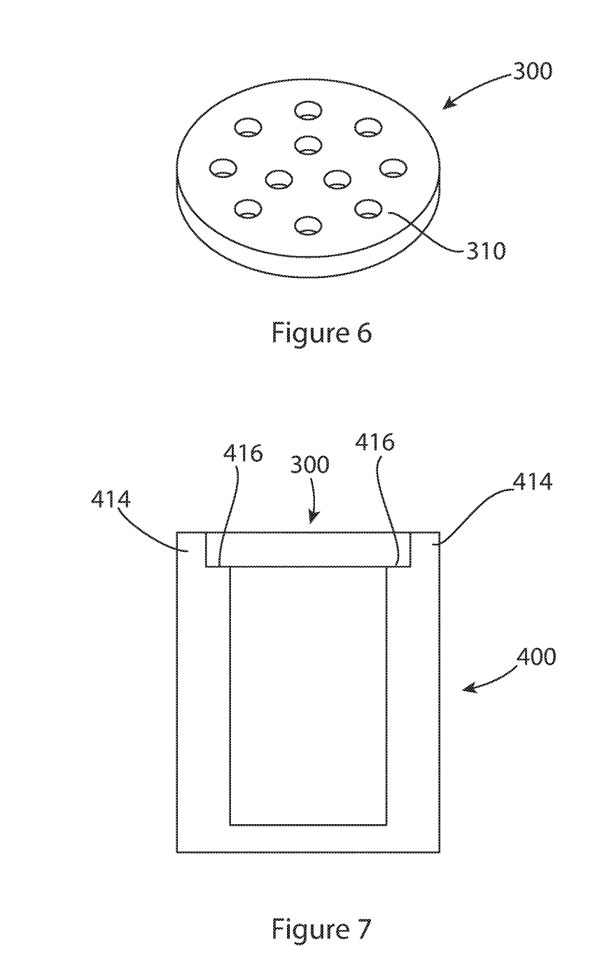

FIG. 6 is a top plan view of an apertured lid 300 for the inner receptacle apparatus of the present disclosure, according to an embodiment of the present disclosure. Referring to FIG. 6, the apertured lid 300 defines a plurality of apertures 310 for receiving flower stems. The apertured lid 300 may be formed from acrylic material such as Perspex®. In an embodiment, the apertured lid 300 may be formed from transparent acrylic material. The apertured lid 300 may comprise a disk or coin-shaped member with holes. However, it will be understood that the apertured lid 300 may be configured to fit the shape defined by the open upper end of the inner receptacle apparatus. The apertured lid 300 may have any suitable shape or structure for being fitted or resting on the upper rim of the inner receptacle apparatus. FIG. 7 is a side view of an inner receptacle apparatus 400 for receiving the apertured lid 300 of FIG. 6, according to an embodiment of the present disclosure. It will be understood that the inner receptacle apparatus 400 comprises one or more adjustable attachment members as described above, but not shown in FIG. 7. Referring to FIG. 7, an upper rim 414 of the inner receptacle apparatus 400 defines an inner recess or ledge 416 configured to receive the apertured lid 300. The apertured lid 300 may thus be configured to fit into the open upper end of the inner receptacle apparatus 400 and rest on the upper rim 414. Flower stems may be inserted into the apertures 310 of the apertured lid 300, and accordingly, a more precise flower arrangement may be facilitated. The apertured lid 300 may be fitted or removed as required.

As described above, the present disclosure provides an inner receptacle apparatus for locating within a larger open-ended outer container. The inner receptacle apparatus comprises a receptacle body suitable for receiving cut flowers, and one or more adjustable attachment members for locating the receptacle body within the outer container. By locating the receptacle body of the inner receptacle apparatus within an outer container, flowers with shorter stems can be accommodated in the inner receptacle apparatus alongside flowers with longer stems in the outer container. In this manner, an arrangement of cut flowers including a variety of flowers with different stem lengths can be facilitated. The inner receptacle apparatus may be configured as described above so that the open upper end of the receptacle body may be positioned at substantially the same height as an open upper end of the outer container.

The words comprises/comprising when used in this specification are to specify the presence of stated features, integers, steps or components but does not preclude the presence or addition of one or more other features, integers, steps, components or groups thereof.

1. An inner receptacle apparatus for locating within a larger open-ended outer container, the inner receptacle apparatus comprising:
a receptacle body for receiving cut flowers; and
one or more adjustable attachment members for locating the receptacle body within the outer container.

2. The apparatus of claim 1, wherein the one or more adjustable attachment members are configured to attach the receptacle body to the outer container.

3. The apparatus of claim 1, wherein each of the one or more adjustable attachment members comprises a first end for attachment to the receptacle body, a linear elongatable body, and a second end for releasable attachment to the outer container.

4. The apparatus of claim 3, wherein the linear elongatable body comprises a retractable spring, a telescopic arrangement, or a retractable chain arrangement.

5. The apparatus of claim 1, wherein each of the one or more adjustable attachment members is hingeably coupled to the receptacle body, the hinging mechanism restricting the rotation of the adjustable attachment member in the vertical plane.
